(19) United States
(12) Patent Application Publication
(10) Pub. No.: US 2020/0153365 A1
(43) Pub. Date: May 14, 2020

(54) ELECTRIC MOTOR HAVING FUNCTION OF CHECKING ENERGIZED STATE OF BRAKE

(71) Applicant: FANUC CORPORATION, Yamanashi (JP)

(72) Inventor: Makoto HAYASHI, Yamanashi (JP)

(21) Appl. No.: 16/578,400

(22) Filed: Sep. 23, 2019

(30) Foreign Application Priority Data
Nov. 12, 2018 (JP) 2018-212526

(51) Int. Cl. H02P 3/04; H02K 7/102

(52) U.S. Cl. CPC H02P 3/04; H02K 7/1025

(57) ABSTRACT

An electric motor according to an embodiment of the present disclosure includes a rotor unit provided with a rotation shaft, a stator unit radially facing the rotor unit, an electromagnetic brake configured to brake the rotation shaft, and a sensor incorporated in the electromagnetic brake to detect an energized state of the electromagnetic brake.

### BACKGROUND OF THE INVENTION

### 1. Field of the Invention

The present invention relates to an electric motor and more particularly to an electric motor having a function of checking an energized state of a brake.

### 2. Description of the Related Art

Heretofore, as described in Japanese Unexamined Patent Application Publication No. 2000-256492, a motor brake device that limits driving of a motor has been reported. To drive a motor (electric motor) having a holding brake, it is necessary to energize an electromagnetic coil in the brake to release the brake. Thus, when the brake is driven in a state of not being properly released due to a forgotten release operation or a disconnected coil, the brake and the motor may malfunction and break down. Conventionally, checking brake release requires a measurement device and operation to check an energized state by measuring a current-voltage waveform of a brake coil.

A technique in the related art for measuring each waveform, a current value, and a voltage value to check an energized state of a brake coil requires many man-hours and measurement devices. Thus, checking a state of the brake each time the motor is driven is not practical and has a risk of driving the motor while the brake is not released.

### SUMMARY OF THE INVENTION

Accordingly, it is desirable to provide an electric motor capable of easily checking an energized state of a brake without using an external measurement device and preventing failure due to driving while the brake is not released.

An electric motor according to an embodiment of the present disclosure includes a rotor unit provided with a rotation shaft, a stator unit radially facing the rotor unit, an electromagnetic brake configured to brake the rotation shaft, and a sensor incorporated in the electromagnetic brake to detect an energized state of the electromagnetic brake.

### BRIEF DESCRIPTION OF THE DRAWINGS

The present invention is more clearly understood with reference to the following attached drawings:

FIG. 1 is a structural diagram of an electric motor according to embodiment 1;

FIG. 2 is a cross-sectional view of an electromagnetic brake provided in the electric motor according to embodiment 1;

FIG. 3A is a cross-sectional view of an electromagnetic brake provided in the electric motor according to embodiment. 1, the electromagnetic brake being operated;

FIG. 3B is a cross-sectional view of the electromagnetic brake provided in the electric motor according to embodiment 1, the electromagnetic brake being released;

FIG. 4 is a cross-sectional view of an electric motor according to embodiment 2;

FIG. 5 is a circuit diagram of a coil and a Hall element of an electromagnetic brake provided in the electric motor according to embodiment 2;

FIG. 6 is another embodiment of a circuit diagram of a coil and a Hall element of an electromagnetic brake provided in the electric motor according to embodiment 2;

FIG. 7 is a cross-sectional view of an electric motor according to embodiment 3;

FIG. 8 is a circuit diagram of a coil of an electromagnetic brake and a clamp current sensor provided in the electric motor according to embodiment 3;

FIG. 9 is a cross-sectional view of an electric motor according to embodiment 4;

FIG. 10 is a cross-sectional view of an electromagnetic brake provided in the electric motor according to embodiment 4;

FIG. 11 is a cross-sectional view of an electric motor according to embodiment 5;

FIG. 12 is a cross-sectional view of an electric motor according to embodiment 6; and

FIG. 13 is a cross-sectional view of an electric motor according to embodiment 7.

### DETAILED DESCRIPTION

Hereinafter, an electric motor according to the present disclosure will be described with reference to the drawings. However, the technical scope of the invention is not limited to these embodiments and includes the invention described in the scope of claims and elements equivalent thereto.

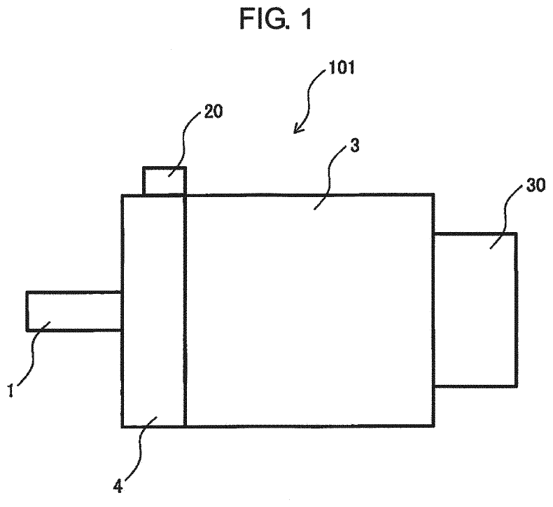

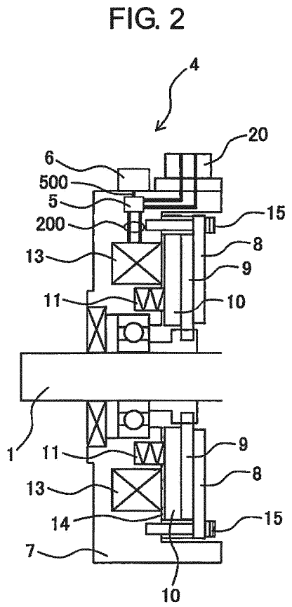

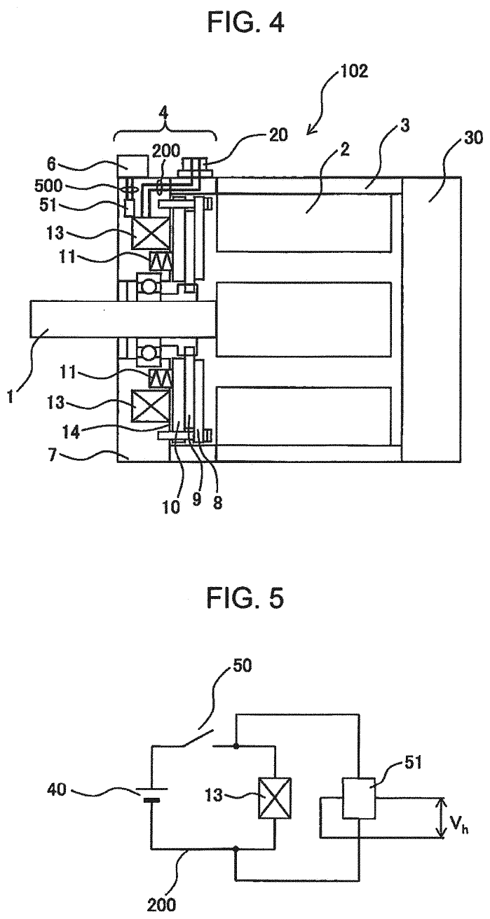

First, an electric motor according to embodiment 1 will be described. FIG. 1 illustrates a structural diagram of an electric motor according to embodiment L. FIG. 2 illustrates a cross-sectional view of an electromagnetic brake provided in the electric motor according to Example 1, the cross-sectional view being taken along a plane passing through a center line of a rotation shaft 1 in FIG. 1. An electric motor 101 according to embodiment 1 includes a rotor unit 2 (refer to FIG. 4) provided with the rotation shaft 1, a stator unit 3 radially facing the rotor unit 2, an electromagnetic brake 4 configured to brake the rotation shaft 1, and a sensor 5 incorporated in the electromagnetic brake 4 to detect an energized state of the electromagnetic brake 4. The electric motor 101 may be provided with a speed sensor 30 configured to detect a rotation speed of the rotation shaft 1.

The electromagnetic brake 4 includes a flange 7, an end plate 8, a friction plate 9, an armature 10, and a spring 11. The flange 7 is provided with a coil 13 wound therearound, and the flange 7 is disposed around the rotation shaft 1. The end plate 8 is fixed to the flange 7 with a bolt 15 while forming a gap with the flange 7.

The friction plate 9 is disposed between the flange 7, and the end plate 8 and is configured to rotate integrally with the rotation shaft 1. The armature 10 is disposed to be movable axially between the flange 7 and the friction plate 9 and is attracted to the flange 7 by electromagnetic force generated by passing a current through the coil 13. The spring 11 is disposed between the flange 7 and the armature 10 and biases the armature 10 toward the end plate 8 to brake and hold the friction plate 9 between the armature 10 and the end plate 8.

Through the coil 13, current flows from a power source (not illustrated) connected to a connector 20 via wiring 200. The sensor 5 is incorporated in the electromagnetic brake 4 and detects an energized state of the coil 13 by detecting a current flowing through the coil 13.

It is preferable to further include an indicator 6 configured to display an energized state of the electromagnetic brake 4 on the basis of an output signal from the sensor 5. The indicator 6 may be a light emitting element such as an LED or may be a display of a computer numerical control (CNC) device. Instead of the indicator, a device configured to emit a sound may be available.

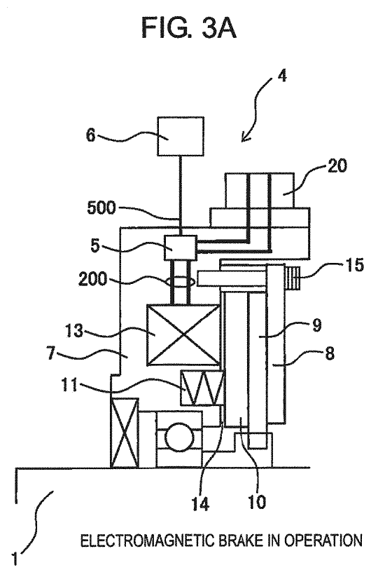

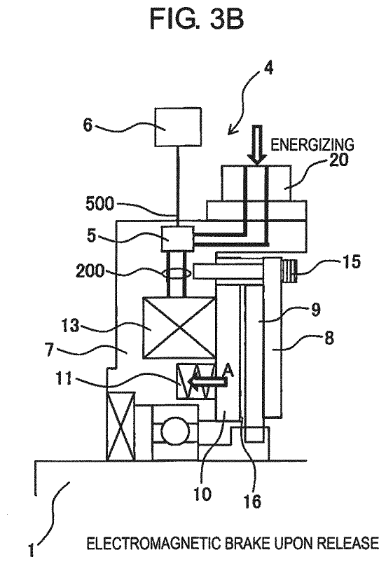

Next, operation of the electromagnetic brake will be described. FIG. 3A illustrates a cross-sectional view of an electromagnetic brake provided in the electric motor according to embodiment 1, the electromagnetic brake being operated. As illustrated in FIG. 3A, in a state of an electromagnetic brake in operation where no current passes through the coil 13, the armature 10 is pressed against the friction plate 9 by the spring 11, so the rotation shaft 1 is held in a non-rotating state. At this time, an air gap 14 is formed between the coil 13 and the armature 10. Then, no current flows through the wiring 200, so the sensor 5 does not output a signal indicating that current is flowing through the wiring 200. The output signal of the sensor 5 is transmitted to the indicator 6 via wiring 500. At this time, the electromagnetic brake 4 is operating, so the indicator 6 does not display information indicating that the electromagnetic brake 4 is released.

Next, release of the electromagnetic brake 4 will be described. FIG. 3B illustrates a cross-sectional view of the electromagnetic brake provided in the electric motor according to embodiment 1, the electromagnetic brake being released. When a current passes from the connector 20 to the coil 13 via the wiring 200, a magnetic field is generated in the coil 13 to attract the armature 10. When this attracting force is stronger than force pressing the armature 10 with the spring 11, the spring 11 is pressed in the direction of arrow A in FIG. 3B to create a gap 16 between the armature 10 and the friction plate 9. As the result, brake on the rotation axis 1 is released to allow the rotation axis 1 to be rotatable. At this time, current flows through the wiring 200, so the sensor 5 detects the current flowing through the wiring 200 and transmits an output signal to the indicator 6. The indicator 6 indicates that the electromagnetic brake 4 is in an energised state, on the basis of the output signal from the sensor 5.

In this way, the indicator 6 can indicate whether the electromagnetic brake 4 is in an energized state. An operator can check whether the electromagnetic brake of the electric motor is released by checking the indication in the indicator 6, so a failure due to driving while the electromagnetic brake is not released can be prevented. The electric motor according to embodiment 1 is also configured such that the sensor configured to detect an energized state is incorporated in the electromagnetic brake, so an energized state of the electromagnetic brake can be easily checked without using an external measurement device.

Next, an electric motor according to embodiment 2 of the present disclosure will be described. FIG. 4 illustrates a cross-sectional view of the electric motor according to embodiment 2. An electric motor 102 according to embodiment 2 is different from the electric motor 101 according to embodiment 1 in that the sensor is a magnetic sensor 51 configured to detect a magnetic field generated by energizing the electromagnetic brake 4. Other configurations of the electric motor 102 according to embodiment 2 are similar to those of the electric motor 101 according to embodiment 1, so detailed description thereof is eliminated.

When a current passes from the connector 20 to the coil 13 via the wiring 200, a magnetic field is generated in the coil 13. The magnetic sensor 51 detects the magnetic field to detect whether the coil 13 is in an energized state. The magnetic sensor 51 can transmit a detection result to the indicator 6 via the wiring 500 so that the indicator 6 can indicate whether the coil 13 is in an energized state.

The magnetic sensor 51 may be a Hall element. FIG. 5 illustrates a circuit diagram of a coil and a Hall element of an electromagnetic brake provided in the electric motor according to embodiment 2. When a switch 50 is brought into conduction, a current flows from the power source 40 to the coil 13. The Hall element 51 is also connected to the power source 40, and a current flows through the Hall element 51. The magnetic field generated in the coil 13 outputs voltage Vₕ to the Hall element 51. Preliminary measuring voltage to be generated across the Hall element 51 when a current at a level sufficient to release the electromagnetic brake 4 flows through the coil 13 enables whether the electromagnetic brake 4 is released from the output voltage Vh of the Hall element 51 to be determined.

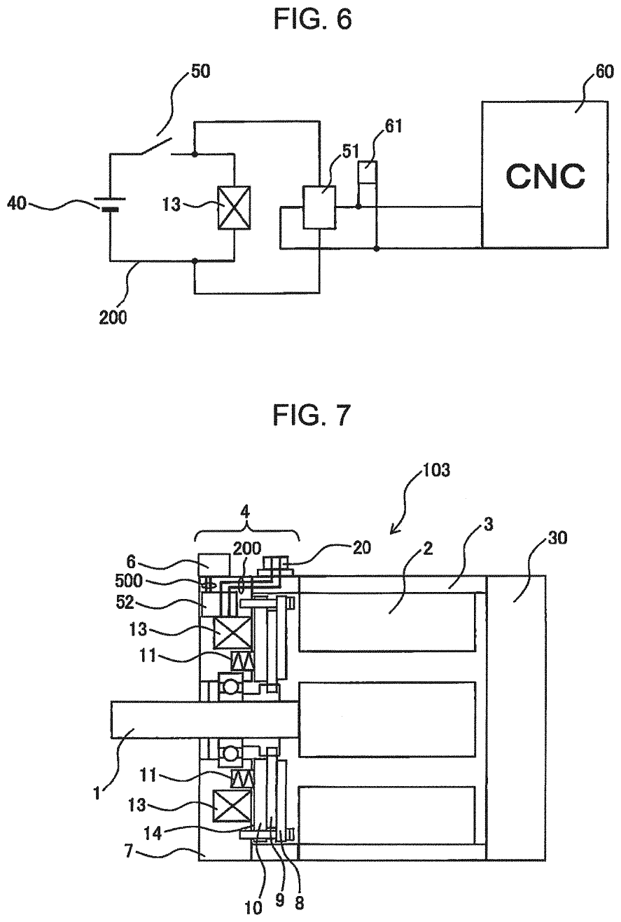

FIG. 6 illustrates another embodiment of a circuit diagram of a coil and a Hall element of an electromagnetic brake provided in the electric motor according to embodiment 2. The Hall element 51 may be connected at its terminal to an LED 61. Such a configuration enables whether the electromagnetic brake 4 is released to be checked by checking whether the LED 61 emits light.

The Hail element 51 also may be connected at its output terminal to a CMC 60. Such a configuration enables indicating whether the electromagnetic brake 4 is released in a display of the CMC 60 or the like and storing a detection result of the Hall element 51 in the CNC 60.

Next, an electric motor according to embodiment 3 of the present disclosure will be described. FIG. 7 illustrates a cross-sectional view of the electric motor according to embodiment 3. An electric motor 103 according to embodiment 3 is different from the electric motor 101 according to embodiment 1 in that the sensor is a current sensor 52 configured to detect current flowing through the electromagnetic brake 4. Other configurations of the electric motor 103 according to embodiment 3 are similar to those of the electric motor 101 according to embodiment 1, so detailed description thereof is eliminated.

The current sensor 52 detects a current flowing from the connector 20 via the wiring 200 to the coil 13 to detect whether the coil 13 is in an energized state. The current sensor 52 may transmit its detection result to the indicator 6 via the wiring 500 to cause the indicator 6 to indicate whether the coil 13 is in an energized state.

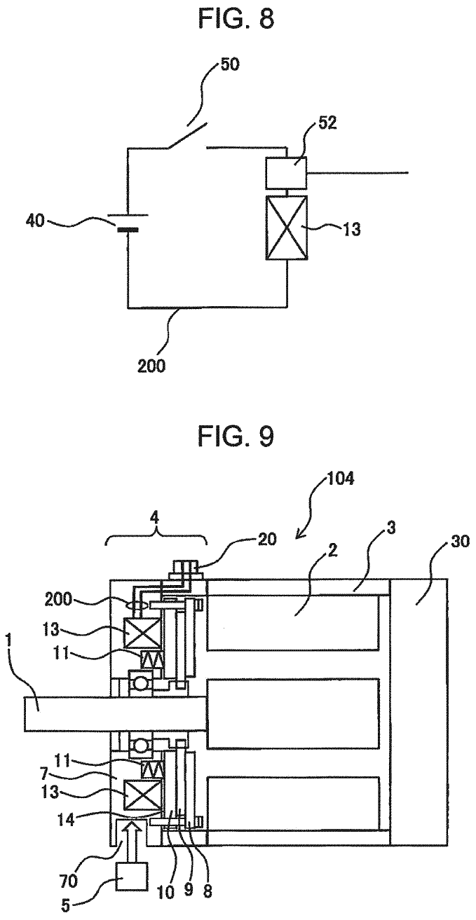

The current sensor 52 may be a clamp sensor. FIG. 8 illustrates a circuit diagram of a coil of an electromagnetic brake and a clamp current sensor provided in the electric motor according to embodiment 3. When the switch 50 is brought into conduction, a current flows from the power source 40 to the coil 13. The clamp sensor 52 detects a current flowing through the wiring 200 from a magnetic field generated in the wiring 200, by clamping the wiring 200. Preliminary measuring current to be detected by the clamp sensor 52 when a current at a level sufficient to release the electromagnetic brake 4 flows through the coil 13 enables whether the electromagnetic brake 4 is released to be determined from a current detected by the clamp sensor 52.

Next, an electric motor according to embodiment 4 of the present disclosure will be described. FIG. 9 illustrates a cross-sectional view of the electric motor according to embodiment 4. An electric motor 104 according to embodiment 4 is different from the electric motor 101 according to embodiment 1 in that the sensor 5 is detachable from the electric motor 104 from outside. Other configurations of the electric motor 104 according to embodiment 4 are similar to those of the electric motor 101 according to embodiment 1, so detailed description thereof is eliminated.

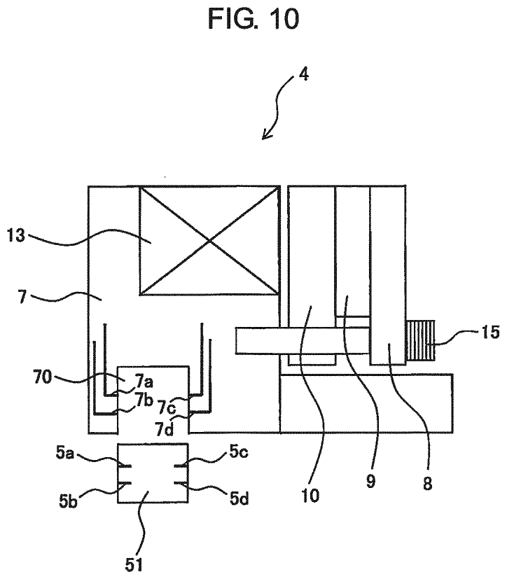

Providing the flange 7 with a recess 70 in which the sensor 5 can be mounted enables the sensor 5 to be detachable. The Hall element 51 can be used for the sensor 5. FIG. 10 illustrates a cross-sectional view of an electromagnetic brake provided in the electric motor according to embodiment 4. The Hall element 51 is preferably configured to be attachable to the recess 70. The Hall element 51 also may be provided with terminals 5a and 5c configured to pass current; and terminals 5b and 5d configured to output voltage generated by a magnetic field to the Hail element 51. In addition, it is preferable that terminals 7a to 7d protrude from a surface of the recess 70, facing the Hall element 51. It is also preferable that the terminals 7a to 7d are respectively connected to the terminal 5a to 5d of the Hall element 51 while the Hall element 51 is mounted in the recess 70. Such a configuration enables a current to be passed through the Hall element 51 via the electromagnetic brake 4. In addition, a detection result of the magnetic field from the coil 13 can be output to the indicator 6 via wiring in the electromagnetic brake.

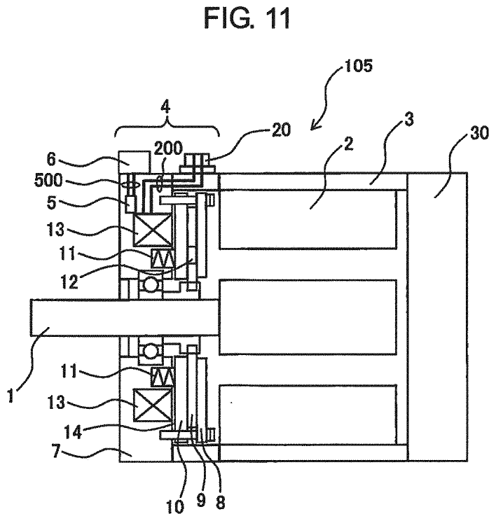

Next, an electric motor according to embodiment 5 of the present disclosure will be described. FIG. 11 illustrates a cross-sectional view of the electric motor according to embodiment 5. An electric motor 105 according to embodiment 5 is different from the electric motor 101 according to embodiment 1 in that the electric motor 105 further includes a contact sensor 12 configured to detect contact between the friction plate 9 and the armature 10. Other configurations of the electric motor 105 according to embodiment 5 are similar to those of the electric motor 101 according to embodiment 1, so detailed description thereof is eliminated.

Combining the sensor 5 and the contact sensor 12 enables finding threshold values of coil voltage (current) when the electromagnetic brake is operated and when the electromagnetic brake is released. The threshold values each change due to abnormal wear of the friction plate, intrusion of cutting fluid, and the like, so a failure of the electromagnetic brake can be predicted. While FIG. 11 illustrates an embodiment in which the friction sensor 12 is provided on the friction plate 9, the friction sensor 12 is not limited to this embodiment, and the friction sensor 12 may be provided on the armature 10.

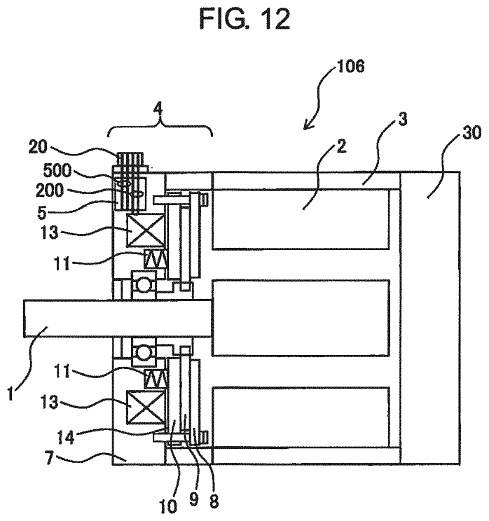

Next, an electric motor according to embodiment 6 of the present disclosure will be described. FIG. 12 illustrates a cross-sectional view of the electric motor according to embodiment 6. An electric motor 106 according to embodiment 6 is different from the electric motor 101 according to embodiment 1 in that the wiring 200 passing current through the coil 13 and the wiring 500 of the sensor 5 are used in common. Other configurations of the electric motor 106 according to embodiment 6 are similar to those of the electric motor 101 according to embodiment 1, so detailed description thereof is eliminated.

When the wiring 200 passing current through the coil 13 and the wiring 500 of the sensor 5 are used in common, both of the wiring 200 and 500 can be connected to the connector 20, and thus wiring in the electromagnetic brake can be simplified.

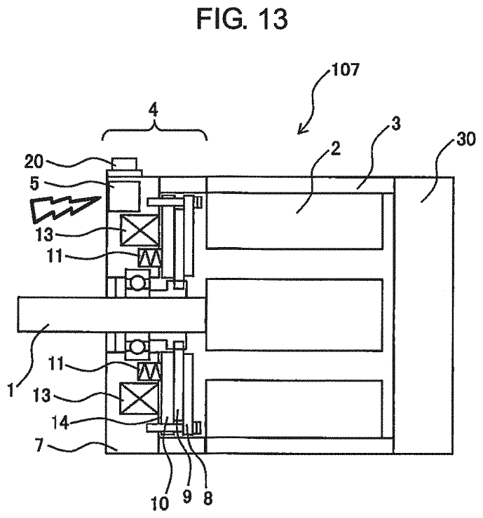

Next, an electric motor according to embodiment 7 of the present disclosure will be described. FIG. 13 illustrates a cross-sectional view of the electric motor according to embodiment 7. An electric motor 107 according to embodiment 7 is different from the electric motor 101 according to embodiment 1 in that the electric motor 107 further includes a transmitter (not illustrated) configured to wirelessly transmit a detection result of the sensor 5 to the outside. Other configurations of the electric motor 107 according to embodiment 7 are similar to those of the electromagnetic device 101 according to embodiment 1, so detailed description thereof is eliminated.

Providing the transmitter configured to wirelessly transmit a detection result of the sensor 5 to the outside enables elimination of wiring for outputting the detection result of the sensor 5 to the outside, so wiring in the electromagnetic brake can be simplified.

The electric motor according to each of embodiments of the present disclosure enables an energized state of the brake to be easily checked without using an external measurement device, and a failure due to driving while the brake is not released to be prevented.

1. An electric motor comprising:
a rotor unit provided with a rotation shaft;
a stator unit radially facing the rotor unit;
an electromagnetic brake configured to brake the rotation shaft; and
a sensor incorporated in the electromagnetic brake to detect an energized state of the electromagnetic brake.

2. The electric motor according to claim 1 further comprising:
an indicator configured to display an energized state of the electromagnetic brake on a basis of an output signal from the sensor.

3. The electric motor according to claim 1, wherein
the sensor is a magnetic sensor configured to detect a magnetic field generated by energizing the electromagnetic brake.

4. The electric motor according to claim 3, wherein
the magnetic sensor is a Hall element.

5. The electric motor according to claim 1, wherein
the sensor is a current sensor configured to detect a current flowing through the electromagnetic brake.

6. The electric motor according to claim 5, wherein
the current sensor is a clamp sensor.

7. The electric motor according to claim 1, wherein
the sensor is detachable from the electric motor from outside.

8. The electric motor according to claim 1, wherein
the electromagnetic brake includes:
a flange provided with a coil wound around the flange, the flange being disposed around the rotation shaft;
an end plate fixed to the flange while forming a gap with the flange;
a friction plate disposed between the flange and the end plate, the friction plate being configured to rotate integrally with the rotation shaft;
an armature disposed to be movable axially between the flange and the friction plate, the armature being configured to be attracted to the flange by electromagnetic force generated by passing a current through the coil;
a spring disposed between the flange and the armature, the spring being configured to bias the armature toward the end plate to brake and hold the friction plate between the armature and the end plate; and
a contact sensor configured to detect contact between the friction plate and the armature.
